(19) United States
(12) Patent Application Publication
(10) Pub. No.: US 2025/0038218 A1
(43) Pub. Date: Jan. 30, 2025

(54) COMPOSITE CURRENT COLLECTOR, MANUFACTURING METHOD THEREOF, ELECTRODE AND LITHIUM-ION BATTERY

(71) Applicant: JIANGYIN NANOPORE INNOVATIVE MATERIALS TECHNOLOGY LTD, Wuxi (CN)

(72) Inventors: Bin JIA, Wuxi (CN); Tianbing WANG, Wuxi (CN); Xuefa LI, Wuxi (CN); Guoping ZHANG, Wuxi (CN)

(21) Appl. No.: 18/716,511

(22) PCT Filed: Dec. 7, 2022
(86) PCT No.: PCT/CN2022/137270

§ 371 Date: Jun. 5, 2024

(30) Foreign Application Priority Data
Dec. 10, 2021 (CN) 202111508933.8
May 23, 2022 (WO) PCT/CN2022/094478

(51) Int. Cl. H01M 4/66; H01M 4/80; H01M 10/0525

(52) U.S. Cl. CPC H01M 4/668; H01M 4/661; H01M 4/80; H01M 10/0525

(57) ABSTRACT

Disclosed herein is a composite current collector, a manufacturing method thereof, an electrode and a lithium-ion battery comprising the composite current collector. The composite current collector comprises: a first porous conductive sheet, a substrate sheet, and a second porous conductive sheet that are laminated in sequence, and the first porous conductive sheet and the second porous conductive sheet comprise amorphous micropores throughout the porous conductive sheets, the substrate sheet is made of a high molecular non-conductive material, and the first porous conductive sheet and the second porous conductive sheet are in conduction with each other in the electrode tab area.

### TECHNICAL FIELD

The present disclosure relates to the technical field of batteries, in particular to a composite current collector, a manufacturing method thereof, an electrode and a lithium-ion battery containing the composite current collector.

### BACKGROUND TECHNOLOGY

Lithium-ion secondary batteries have widely been used in various commercial electronic products due to their high energy density and superior cycle stability compared to other rechargeable batteries.

The existing lithium-ion battery adopts a smooth copper foil as the negative electrode. Since the surface of the copper foil is smooth, the adhesion of the copper foil to the negative electrode active material is not ideal in use. In addition, the smooth copper foil makes it difficult for the negative electrode active material to be evenly distributed on its surface, and thus it is easy to form lithium dendrites at the negative electrode during the charging process. The formed lithium dendrites are prone to penetrate the separator in the lithium-ion battery to be in contact with the positive electrode or fall off from the negative electrode to form inactive lithium, thereby affecting the safety and service life of the lithium-ion battery.

### SUMMARY OF THE DISCLOSURE

To resolve the above-mentioned problems, the present inventors provide a novel composite current collector to improve the adhesion of the positive electrode active material or the negative electrode active material on its surface, and to better suppress the formation of lithium dendrites. Furthermore, the present disclosure also provides a method of manufacturing the composite current collector, and an electrode and a secondary battery containing the composite current collector.

Disclosed herein is a composite current collector, comprising:
a substrate; a first porous conductive sheet; and a second porous conductive sheet, wherein the first porous conductive sheet and the second porous conductive sheet are laminated on the opposing surface of the substrate; the first porous conductive sheet and/or the second porous conductive sheet comprises amorphous micropores throughout the porous conductive sheets; and the first porous conductive sheet and the second porous conductive sheet are in conduction with each other in an electrode tab area. For the composite current collector disclosed herein, amorphous micropores are formed throughout the first and/or second porous conductive sheet(s). They are formed on the surface of and/or within the first and/or second porous conductive sheet. When the porous conductive sheet is placed in contact with an active material, e.g., the negative electrode active material in a lithium-ion battery, such amorphous micropores can improve the adsorption of the active material, so that the active material can adhere better to the first porous conductive sheet and/or the second porous conductive sheet. In some embodiments, the amorphous micropores of the first porous conductive sheet and/or the second porous conductive sheet are uniformly distributed, they can make the active material uniformly distributed when adhering thereto, which can minimize or avoid the formation of lithium dendrites; further, the resulting composite current collector can have a good buffer effect. For example, when the composite current collector disclosed herein is used as a negative electrode, and when lithium ions enter into the negative electrode active material, the volume of the composite current collector may expand, and the amorphous micropores therein can better absorb the stress caused by expansion of the negative electrode active material. Finally, the substrate sheet, which is made of a high molecular non-conductive material, can provide better support for the first porous conductive sheet and the second porous conductive sheet to prevent deformation thereof, and can also insulate the active material.

As disclosed herein, the amorphous micropores are, for example, interpenetrated micropores, which may have different pore diameters and form a pore network within the sheets. In addition, the amorphous micropores are distributed throughout the porous conductive sheets; that means, the amorphous micropores may be distributed on the surface and/or inside the porous conductive sheets. In some embodiments, the amorphous micropores extend over the sheet area in the transverse direction, as exemplified in FIG. 5. Further, in some embodiments, the amorphous micropores are distributed along the thickness of the porous conductive sheets and thus lead to interpenetrated porous network at the cross-section, as exemplified in FIG. 6. In addition, in some embodiments, the amorphous micropores are distributed inside the entire volume of the porous conductive sheets, horizontally and vertically, forming partially or completely interpenetrated-pore-network. Furthermore, in some embodiments, the amorphous micropores are distributed throughout both the first and the second porous conductive sheets. In some embodiments, the micropores are uniformly distributed within the first and/or the second porous sheet. The micropores disclosed herein are pores having diameter of less than 1 μm. Preferably, 60% or more of the micropores in the first and/or second porous sheet have a pore diameter ranging from 1 nm to 999 nm, more preferably 80% or more of the micropores in the first and/or second porous sheet have a pore diameter ranging from 10 nm to 800 nm, even more preferably, 80% or more of the micropores have a pore diameter ranging from 50 nm to 400 nm, further preferably 90% or more of the micropores have a pore diameter ranging from 50 nm to 400 nm.

The porous sheets disclosed herein may have a porosity ranging, for example, from 5% to 50%, preferably from 10% to 30%, more preferably from 10% to 25%. The porosity of the porous sheet disclosed herein is a ratio of the volume of pores to the sum of the volume of the pores and the volume of the porous sheet. When the porosity of the conductive sheet is too low, the anti-swelling property of the current collector during the charging and discharging process of the battery can be deteriorated. The anti-swelling property of a current collector refers to the ability of the current collector to accommodate the expanded volume of the electrode active materials and/or the electrolytes, and hence resist the pressure resulted therefrom. When the porosity of the conductive sheet is too high, the sheet resistance of the composite current collector with the same thickness can be too large, which will affect the battery performance.

In one embodiment of the present disclosure, the material of the first and/or porous conductive sheet is metal. Preferably, the material of the first and/or second porous conductive sheet is copper.

In one embodiment of the present disclosure, the material of the first and/or porous conductive sheet is a metallic composition, preferably an alloy. The metallic composition can, for example, be a metallic composition comprising copper and a second metallic compound. The second metallic compound is capable to react with an acidic solution. The second metallic compound is preferably selected from a second metal element other than copper and a metal oxide. The second metal element can, for example, be manganese, zinc, magnesium, or aluminum. The second metallic oxide can, for example, be copper oxide. The acidic solution may be any conventional acidic solution. For example, the acidic solution can be a solution comprising an acid selected from acetic acid, citric acid, hydrochloric acid, phosphoric acid, sulfuric acid, and nitric acid. The content of copper in the first and/or porous conductive sheet may be equal to or greater than 60 wt. %, preferably the content of copper is equal to or greater than 80 wt. %. When the content of copper in the porous conductive sheet is too low, the sheet resistance may become high and the conductivity of the current collector may not be ideal.

The first porous conductive sheet and the second porous conductive sheet may be made of the same or different material. Preferably, the first and the second porous conductive sheet are made of the same material. Preferably, the first and the second porous conductive sheet are made of copper-zinc alloy.

The thickness of the first porous conductive sheet may range, for example, from 0.5 μm to 3 μm, preferably from 0.8 μm to 2 μm. The thickness of the second porous conductive sheet may range, for example, from 0.5 μm to 3 μm, preferably from 0.8 μm to 2 μm. The first porous conductive sheet and the second porous conductive sheet may have the same or different thickness.

In one embodiment of the present disclosure, the substrate sheet is made of a high molecular non-conductive material, preferably the non-conductive material is selected from polyethylene terephthalate, polypropylene, polyethylene, polyimide, polyether ether ketone, and the combination thereof.

The thickness of the substrate sheet ranges, for example, from 1 μm to 30 μm, preferably from 2 μm to 10 μm, more preferably from 4 μm to 8 μm.

The present disclosure also provides a method to make a composite current collector. Conventional methods to provide micropores on a conductive sheet include the colloidal crystal template method, the laser-based blind hole processing method, and the solid-phase sintering method, etc. However, such method either requires costly and special manufacturing equipment or the process flow as such is complicated and needs to be carefully controlled. Therefore, when considering a manufacturing process with simple flow and low cost, the present inventors surprising found a simple chemical corrosion process, which overcomes the drawbacks of the existing methods and provides the composite current collector with amorphous micropores as disclosed herein.

Disclosed herein is a method of making a composite current collector, comprising:
providing a substrate, preferably, the substrate is made of a high molecular non-conductive material and has a thickness ranging, for example, from 2 μm to 10 μm;
depositing a first metallic composition and a second metallic composition respectively on the opposite sides of the substrate, preferably by vapor deposition, preferably the first metallic composition and the second metallic composition independently comprises copper and a second metallic compound, wherein the second metallic compound is capable to react with an acidic solution;
contacting the deposited first and the second metallic compositions with an acid solution to corrode the second metallic compound, so as to form the first porous conductive sheet and the second porous conductive sheet respectively on the opposite sides of the substrate sheet;
washing away the acidic solution with clean water; and
optionally performing anti-oxidation treatment for the composite current collector at a temperature ranging, for example, from 120° C. to 150° C.

The substrate may be fabricated by any conventional method. For example, it may be processed by stretching to obtain a substrate sheet with a thickness raging, for example, from 1 μm to 30 μm, preferably from 2 μm to 10 μm, more preferably from 4 μm to 8 μm. The material of the substrate may be non-conductive material selected from polyethylene terephthalate, polypropylene, polyethylene, polyimide, polyether ether ketone, and the combination thereof.

The first metallic composition and the second metallic composition may independently comprise copper ranging, for example, from 60% to 95% by weight of the total weight of the first or the second metallic composition. If the content of the copper is too high, the resulting porous conductive sheet may have low porosity and the adhesion to the active material may not be ideal; and the anti-swelling property of the current collector during the charging and discharging process of the battery can be deteriorated. On the contrary, if the content of the copper is too low, the porosity of the porous sheet may be too high and thus the sheet resistance is increased so that the conductivity is compromised.

The acidic solution may be any conventional acidic solution, which is capable of reacting with the second metallic compound according to the present disclosure. The acidic solution may be an aqueous solution comprising one or more acids selected from acetic acid, citric acid, hydrochloric acid, sulfuric acid, nitric acid and the combination thereof. The concentration of the acid in the acidic solution may range, for example, from 0.05 mol/L to 10 mol/L, preferably from 0.5 mol/L to 8 mol/L, more preferably from 1 mol/L to 5 mol/L, depending on the reaction conditions and the required extent of corrosion. Such acid solution may uniformly corrode the deposited metallic composition by reacting with the second metallic compound under, for example, mild conditions. The acidic solution, however, should not react with copper under the conditions disclosed herein.

As disclosed herein, the first and the second metallic compositions are in contact with the acid solution for a time period ranging, for example, from 5 minutes to 30 minutes, preferably from 5 minutes to 15 minutes, more preferably from 5 minutes to 10 minutes; preferably at a temperature ranging, for example, from 20° C. to 70° C., preferably from 20° C. to 30° C., more preferably at room temperature to achieve the desirable extent of corrosion.

The present disclosure also provides herewith an electrode, containing the composite current collector according to the present disclosure. The first porous conductive sheet and the second porous conductive sheet are in conduction with each other in an electrode tab area.

The present disclosure further provides a lithium-ion battery, containing the electrode according to the present disclosure.

### DESCRIPTION OF THE DRAWINGS

FIG. 1 is a diagram of the structure of a composite current collector according to one embodiment of the present disclosure;

FIG. 2 is an exploded-view drawing of the composite current collector in FIG. 1;

FIG. 3 is a flowchart of a manufacturing method in an Example of the present disclosure;

FIG. 4 is an XRD pattern of a Cu—Mn film before and after corrosion in acidic solution.

FIG. 5 is SEM picture of the surface of the porous conductive sheet according to example 1 of the present disclosure.

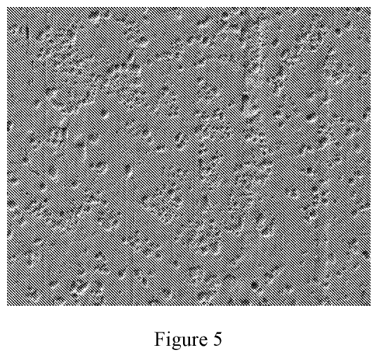

FIG. 6 is SEM picture of the cross-section of a porous conductive sheet according to example 10 of the present disclosure.

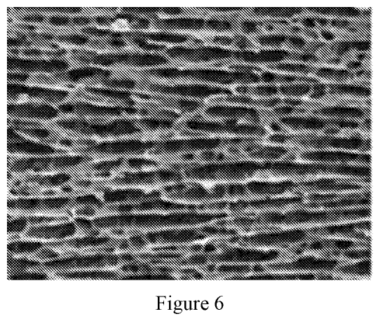

### SPECIFIC EMBODIMENTS

In order to illustrate the objects, features, and advantages of the present disclosure, specific embodiments of the present disclosure are described in detail below with reference to the accompanying drawings. The present disclosure can be implemented in many ways different from those described herein, and those skilled in the art can make similar improvements without departing from the spirit and connotation of the present disclosure. Therefore, the present disclosure is not limited by the specific embodiments below.

As disclosed herein, it should be understood that the orientations or position relations indicated by such terms as “center”, “longitudinal”, “lateral”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, and “circumferential” are based on the orientations or position relations shown in the accompanying drawings, and are only for the convenience of describing the present disclosure, rather than indicating or implying the indicated devices or elements must have a particular orientation, be constructed and operated in a particular orientation, so the same cannot be construed as limitations of the present disclosure.

In addition, the terms “first” and “second” are used for descriptive purposes, and cannot be construed as indicating or implying relative importance or implying the number of indicated technical features. Thus, a feature with “first” or “second” may expressly or implicitly include at least one of the features, further as disclosure herein, “a” means one or more; and “several” means at least two, e.g., two, three, etc., unless otherwise expressly and specifically limited.

Further, unless otherwise expressly specified and limited, such terms as “installation”, “interconnection”, “connection”, and “fixation” shall be understood in a broad sense, for example, it may be a fixed connection or a detachable connection, or an integrated connection; it may be a mechanical connection or an electrical connection; it may be a direct connection or indirect connection through an intermediate medium, and it may be the internal connection of two elements or the interaction relationship between the two elements, unless otherwise specifically limited. For those of ordinary skill in the art, the specific meanings of the above terms in the present disclosure can be understood accordingly.

In addition, unless otherwise expressly specified and limited, in the event that the first feature is “above” or “under” the second feature, it may indicate that the first feature is in direct contact with the second feature, or the first feature is in direct contact with the second feature through an intermediate medium. Furthermore, in the event that the first feature is “on”, “above” or “over” the second feature, it may indicate that the first feature is directly above or obliquely above the second feature, or it simply indicates that the level of the first feature is higher than that of the second feature. Further, in the event that the first feature is “below”, “underneath” or “under” the second feature, it may indicate that the first feature is directly below or obliquely below the second feature, or it simply indicates that the level of the first feature is lower than that of the second feature.

It should be noted that when an element is described as being “fixed to” or “arranged on” another element, it can be directly on the other element or there may be an element between them. When an element is described as being “connected” to another element, it can be directly connected to the other element or there may be an element between them. The terms “vertical”, “horizontal”, “upper”, “lower”, “left”, “right” and similar expressions used herein are for the purpose of illustration only and do not represent the only embodiment.

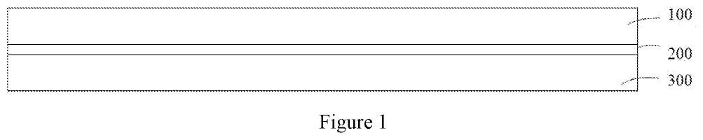

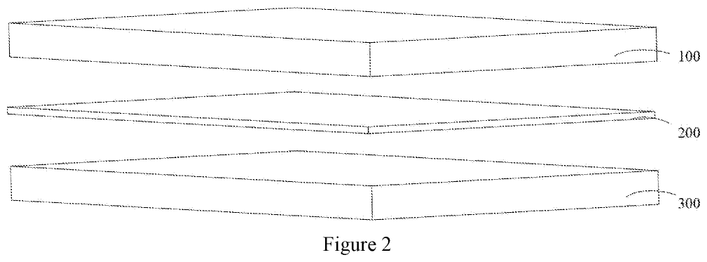

In FIGS. 1 and 2, a composite current collector in one embodiment of the present disclosure comprises: a first porous conductive sheet 100, a substrate sheet 200, and a second porous conductive sheet 300, wherein the first porous conductive sheet 100 and the second porous conductive sheet 300 are used to carry the positive electrode active material or the negative electrode active material, the substrate sheet 200 is used to support the first porous conductive sheet 100 and the second porous conductive sheet 300 and can insulate and isolate the positive electrode active material or the negative electrode active material on the first porous conductive sheet 100 and the second porous conductive sheet 300. The present disclosure provides better adsorption for the positive electrode active material or the negative electrode active material by providing amorphous micropores in the first porous conductive sheet 100 and the second porous conductive sheet 300. Due to, for example, the uniform distribution of the micropores, the formation of lithium dendrites can also be well suppressed.

As one of ordinary skill in the art understands it, a lithium-ion battery mainly comprises positive electrode, positive electrode active material, negative electrode, negative electrode active material, separator, electrolyte, and battery shell. In general, for example, aluminum foil serves as the positive electrode, lithium intercalated metal oxide serves as the positive electrode active material; copper foil serves as the negative electrode, and lithium intercalated carbon-based or non-carbon-based material serves as the negative electrode active material. The positive electrode and the negative electrode described above can be understood as the composite current collector referred to in the present disclosure, and the composite current collector mainly plays the role of conducting the current, and can be generally understood as a wire.

When the lithium-ion battery is charged, lithium ions are deintercalated from the positive electrode active material into the electrolyte, pass through the separator, reach and are intercalated into the negative electrode active material, and meanwhile, electrons enter into the negative electrode through the external circuit to achieve the charge balance; during discharge, lithium ions are deintercalated from the negative electrode active material into the electrolyte, pass through the separator, and are intercalated into the positive electrode active material, and likewise, electrons enter into the positive electrode from the external circuit.

Taking the negative electrode as an example, since smooth copper foil generally serves, for example, as the negative electrode, there is a problem that it is often difficult for the negative electrode active material to adhere to the surface of the smooth copper foil, i.e., the smooth copper foil has poor adhesion, and this also makes it difficult for the negative electrode active material to be evenly distributed on the surface of the copper foil. For example, the negative electrode active material does not adhere to the copper foil in some areas during the adhering process, or the adhered negative electrode active material falls off the smooth copper foil, resulting in uneven distribution. Due to the uneven distribution of the negative electrode active material on the copper foil, during the charging process of the lithium-ion battery, lithium ions will nucleate and grow unevenly on the negative electrode active material, so the negative electrode active material will crack, and the deposition rate of lithium ions at the cracks is higher than that in other areas, which further aggravates the growth of lithium dendrites. The main problems due to the growth of lithium dendrites include: first, the growing lithium dendrites will pierce the separator of the lithium-ion battery and extend to the negative electrode, thereby causing a short circuit inside the battery; second, in the process of charging and discharging, if the lithium dendrites fall off the negative electrode to form inactive lithium, which will affect the service life of lithium-ion batteries.

In this example of the present disclosure, the composite current collector discloses herein comprises a first porous conductive sheet 100, a substrate sheet 200, and a second porous conductive sheet 300 that are laminated in sequence, and the pores on the first porous conductive sheet 100 and the second porous conductive sheet 300 are micropores and are, for example, evenly distributed, of which the diameter ranges from 2 nm to 50 nm, the substrate material sheet 200 is made of a high molecular insulating material, and the first porous conductive sheet 100 and the second porous conductive sheet 300 are connected in the electrode tab area. The electrode tab area can be understood as where the first porous conductive sheet 100 joins with the second porous conductive sheet 300.

In this example, amorphous micropores are formed on the surface of and within the first porous conductive sheet 100 and the second porous conductive sheet 300, and when in contact with an active material, e.g., the active material of negative electrode in a lithium-ion battery, such amorphous micropores can provide better adsorption of the active material, so that the active material can adhere well to the first porous conductive sheet 100 and/or the second porous conductive sheet 300. Secondly, since the amorphous micropores of the first porous conductive sheet 100 and the second porous conductive sheet 300 are uniformly distributed, it can make the active material uniformly distributed when adhering thereto, which minimizes or avoids the formation of lithium dendrites; and it can also provide the composite current collector with a good buffer effect. For example, when the composite current collector disclosed herein is used as the negative electrode, when lithium ions enter into the negative electrode active material, the volume of the composite current collector will expand, and the micropores therein can better absorb the stress caused by expansion of the negative electrode active material. Finally, the substrate sheet made of high molecular non-conductive material can provide better support for the first porous conductive sheet 100 and the second porous conductive sheet 300 to prevent deformation thereof, and can also insulate the positive electrode active material and/or negative electrode active material on the first porous conductive sheet 100 and the second porous conductive sheet 300.

The material of the first porous conductive sheet 100 and the second porous conductive sheet 300 in the composite current collector should have the following desirable characteristics: it should have good electrical conductivity to facilitate the conduction of the current; it should be soft so that the positive electrode active material or the negative electrode active material can adhere thereto; in addition, it should be as easily available as possible with low cost, and should have high stability.

When the composite current collector is used as the positive electrode, aluminum and nickel materials can, for example, be selected. When the aluminum material is used as the positive electrode, the reduction reaction with the electrolyte can be well avoided; nickel is stable in both acid and alkaline electrolyte, so a composite current collector made of nickel can be used as a current collector on the positive electrode or on the negative electrode.

When the composite current collector is used as the negative electrode, copper material can, for example, be selected. When copper is used as the negative electrode, copper is easily oxidized at a higher potential of the positive electrode, so copper is generally not used as the positive electrode. When copper is used as the negative electrode, the active material of the negative electrode is generally selected, for example, from graphite, silicon, tin, and cobalt-tin alloy.

In one embodiment, the first porous conductive sheet 100 and the second porous conductive sheet 300 are made of the same material. Both the first and the second porous conductive sheet are produced by corroding a sheet made of metallic compositions. The metallic compositions are selected from copper-zinc alloy, copper-manganese alloy, copper-magnesium alloy, copper-aluminum alloy, and copper-copper oxide mixture. The reason is that copper foil is generally used as the current collector at the negative electrode of secondary batteries at present, and there are two main production processes for copper foil, and copper foil is mainly divided into rolled copper foil and electrolytic copper foil. Compared with electrolytic copper foil, rolled copper foil has higher electrical conductivity and better extension effect, but the difficult control of its production process and high cost of raw materials limit the application of rolled copper foil; the raw materials of electrolytic copper foil can be re-refined from scrap copper, scrap cables and other waste materials, with a low cost, which can help implement the strategy of sustainable development. Therefore, after the copper is obtained by electrolysis, it can be further made into a copper-zinc alloy, copper-manganese alloy, copper-magnesium alloy, copper-aluminum alloy or copper-copper oxide mixture, and then the second metallic compound other than copper can be corroded with an acidic solution so as to obtain the first porous conductive sheet 100 and the second porous conductive sheet 300, which are copper-containing sheets with amorphous micropores.

In the production of a lithium-ion battery, when selecting a composite current collector according to the actual size of the lithium-ion battery, generally the thickness of the first porous conductive sheet 100 ranges, for example, from 0.8 μm to 2 μm, the thickness of the second porous conductive sheet 300 ranges, for example, from 0.8 μm to 2 μm, and the thickness of the first porous conductive sheet 100 and the thickness of the second porous conductive sheet 300 can be the same.

When arranging the first porous conductive sheet 100 and the second porous conductive sheet 300 on the substrate sheet 200, three aspects need to be considered. First, the substrate sheet 200 should have good ductility, so that the first porous conductive sheet 100 and the second porous conductive sheet 300 can be arranged on the substrate sheet 200 after the substrate sheet 200 is stretched or cast; second, substrate sheet 200 should have high strength, so that it can support well the first porous conductive sheet 100 and the second porous conductive sheet 300 in the charging and discharging process of the lithium-ion battery; third, the substrate sheet 200 should be able to prevent the conduction between the active materials on the first porous conductive sheet 100 and the second porous conductive sheet 300. Therefore, when selecting the substrate sheet 200, the substrate sheet 200 may be made of one or two non-conductive materials selected from polyethylene terephthalate, polypropylene, polyethylene, polyimide, and polyether ether ketone.

In addition, the thickness of the substrate sheet 200 can be determined according to the size of the lithium-ion battery. In this example, the thickness of the substrate sheet 200 ranges from 2 μm to 10 μm.

The composite current collector disclosed herein can, for example, be used as the negative electrode in a lithium-ion battery. Both the first porous conductive sheet 100 and the second porous conductive sheet 300 of the composite current collector adopt a copper-containing sheet made from copper-containing alloy by corroding a second metallic compound with an acidic solution, and the substrate sheet 200 is made of a high molecular insulating material, which can be selected from polyethylene terephthalate, polypropylene, polyethylene, polyimide, and polyether ether ketone. The thickness of the substrate sheet 200 ranges from 2 μm to 10 μm, and the thicknesses of the first porous conductive sheet 100 and the second porous conductive sheet 300 are the same, which ranges from 0.8 μm to 2 μm.

In another embodiment, the composite current collector disclosed herein can also be used, for example, as the negative electrode of a lithium-ion battery. Both the first porous conductive sheet 100 and the second porous conductive sheet 300 are copper-containing sheets with micropores made from copper-containing alloy by corroding a second metallic compound with an acidic solution, and the copper-containing sheet material used as the negative electrode can better avoid oxidation by the electrolyte; in addition, on the copper-containing sheet with micropores formed by corroding the second metallic compound in the copper-containing alloy, the distribution of the micropores is relatively uniform. When the negative electrode active material is arranged on the copper-containing sheet with amorphous micropores, the amorphous micropores on the copper-containing sheet with amorphous micropores can better adsorb the negative electrode active material. In addition, since the micropores on the porous copper-containing sheet are relatively uniformly distributed, it can make the negative electrode active material uniformly distributed when adhering thereto, which minimizes or avoids the formation of lithium dendrites; it can also result in a good buffer effect of the copper-containing sheet, which can absorb well the stress generated by the volume expansion of the copper-containing sheet after the lithium ions entering into the negative electrode active material during the charging process. In addition, the substrate sheet made of high molecular non-conductive material can provide good support for the copper-containing sheet, and can also prevent the negative electrode active materials arranged on the copper-containing sheet from being in direct conduction, thereby achieving an insulating effect.

When the composite current collector disclosed herein was used as the negative electrode of a lithium-ion battery, and graphite was used as the negative electrode active material, the coulombic efficiency of the battery was 98%; when smooth copper foil was used as the negative electrode of a lithium-ion battery, and graphite was also used as the negative electrode active material, the coulombic efficiency of the battery was 93%. Therefore, when the composite current collector disclosed herein is used as the negative electrode of lithium-ion battery, it can improve the coulombic efficiency. In addition, in a comparative test, the capacity retention rate of a lithium-ion battery using smooth copper foil as the negative electrode was 68% after 250 cycles of charging and discharging of the lithium-ion battery, while the capacity retention rate of a lithium-ion battery using the composite current collector disclosed herein as the negative electrode was still higher than 90% after 300 cycles of charging and discharging. Therefore, the composite current collector disclosed herein is superior to the smooth copper foil in terms of improving the coulombic efficiency and service life of the lithium-ion battery.

Further disclosed herein are exemplary composite current collectors made from different alloys, all of which include the amorphous micropores distributed therein after the acid corrosion operations. The porosity and/or the porous conductive sheets can be controlled by employing different reaction conditions.

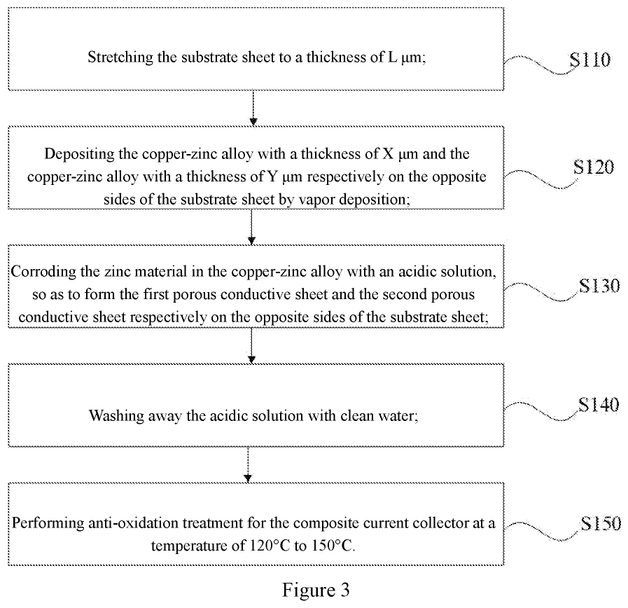

In order to better form the micropores in the first porous conductive sheet 100 and the second porous conductive sheet 300 of the composite current collector disclosed herein, the present inventors also provide a method of making the composite current collector according to the present disclosure, for example, a chemical corrosion process for forming the micropores. Specifically, disclosed herein is a method for making a composite current collector as reflected in the flow chart shown in FIG. 3. In this example, the material of the first porous conductive sheet 100 and the second porous conductive sheet 300 is a copper-containing alloy, and the substrate sheet 200 is made of polyethylene terephthalate, polypropylene, polyethylene, polyimide, or polyether ether ketone. Specifically, an exemplary manufacturing method comprises:

S110, providing a substrate sheet 200, stretching the substrate sheet 200 to a thickness of L μm;

S120, depositing the copper-containing alloy with a thickness of X μm and the copper-containing alloy with a thickness of Y μm respectively on the opposite sides of the substrate sheet 200 by vapor deposition;

S130, corroding a second metallic compound material in the copper-containing alloy with an acidic solution, so as to form the first porous conductive sheet 100 and the second porous conductive sheet 300 respectively on the opposite sides of the substrate sheet 200;

S140, washing away the acidic solution with clean water;

S150, performing anti-oxidation treatment for the composite current collector at a temperature ranging from 120° C. to 150° C.

The stretched thickness of the substrate sheet 200 can be determined according to the actual size of the lithium-ion battery and the corresponding sizes of the first porous conductive sheet 100 and the second porous conductive sheet 300. For example, the substrate sheet 200 can be stretched to a thickness ranging from 2 μm to 10 μm. The copper-zinc alloy with a thickness of X μm and the copper-zinc alloy with a thickness of Y μm are deposited respectively on the opposite sides of the substrate sheet 200 by vapor deposition, in which the X and Y can be the same, e.g., both range from 0.8 μm to 2 μm. In addition, the acid solution used can be 5% to 10% of dilute hydrochloric acid, and the composite current collector is immersed in the dilute hydrochloric acid for a period of time ranging from 1 to 5 minutes, or a coiling system can be used for continuous deposition, so that the zinc element in the copper-zinc alloy is corroded by the dilute hydrochloric acid as completely as possible.

### EXAMPLES

In the following examples, the pore size distribution of the composite current collector disclosed herein was measured using a gas permeation porometer.

The porosity of the sample, when the second metallic compound was completely reacted, is calculated as follows:

$$Porosity = {V}_{second - metallic - compound} \div ( {V}_{Cu} + {V}_{second - metallic - compound} ) = ( {m}_{second - metallic - compound} \div {ρ}_{second - metallic - compound} ) \div ( {m}_{C u} \div {ρ}_{C u} + {m}_{second - metallic - compound} \div {ρ}_{second - metallic - compound} ) \qquad Equation 1$$

When the second metallic compound, such as, Zn, Mn, and CuO, was not completely reacted, the porosity of the sample is calculated as follows:

$$Porosity = {V}_{c o r r o s i o n} \div ( {V}_{C u} + {V}_{second - metallic - compound} ) = ( {m}_{c o r r o s i o n} \div {ρ}_{second - metallic - compound} ) \div ( {m}_{C u} \div {ρ}_{C u} + {m}_{second - metallic - compound} \div {ρ}_{second - metallic - compound} ) \qquad Equation 2$$

The corroded mass (m_{corrosion}) is determined by measuring the mass difference of the sample before and after the corrosion.

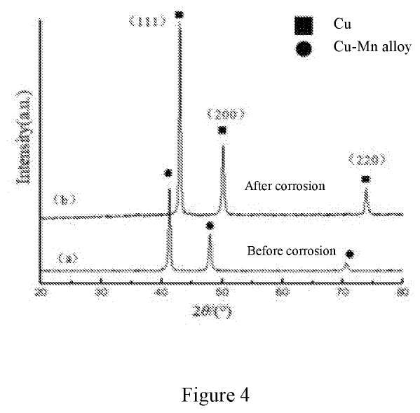

The extent of corrosion was assessed using XRD, as exemplified in FIG. 4.

Example 1: High-purity brass (containing 5 wt.-% of zinc) was used, which was sputtered to a substrate made of polyethylene terephthalate through uniform (magnetron) sputtering. A 1.5 μm-thick alloy layer was deposited on the two opposite sides of the substrate sheet. A 10*10 mm sample was taken and soaked in a 4 mol/L of hydrochloric acid solution at room temperature for 5 min. As the zinc in the sample gradually reacted with the hydrochloric acid solution, (hydrogen) bubbles appeared on the surface, and the color gradually changed from golden yellow to purple brown. After the reaction was over, the acidic solution was washed off with clean water, and the resulting sample was dried in a vacuum environment to finally obtain a three-dimensional interpenetrated porous composite copper foil.

Example 2: High-purity brass (containing 15 wt.-% of zinc) was used, which was sputtered to a substrate made of polyethylene terephthalate through uniform (magnetron) sputtering. A 1.5 μm-thick alloy layer was deposited on the two opposite sides of the substrate sheet. A 10*10 mm sample was taken and soaked in a 4 mol/L of hydrochloric acid solution at room temperature for 5 min. As the zinc in the sample gradually reacted with the hydrochloric acid solution, (hydrogen) bubbles appeared on the surface, and the color gradually changed from golden yellow to purple brown. After the reaction was over, the acidic solution was washed off with clean water, and the resulting sample was dried in a vacuum environment to finally obtain a three-dimensional interpenetrated porous composite copper foil.

Example 3: High-purity brass (containing 15 wt.-% of zinc) was used, which was sputtered to a substrate made of polyethylene terephthalate through uniform (magnetron) sputtering. A 1.5 μm-thick alloy layer was deposited on the two opposite sides of the substrate sheet. A 10*10 mm sample was taken and soaked in a 4 mol/L of hydrochloric acid solution at room temperature for 10 min. As the zinc in the sample gradually reacted with the hydrochloric acid solution, (hydrogen) bubbles appeared on the surface, and the color gradually changed from golden yellow to purple brown. After the reaction was over, the acidic solution was washed off with clean water, and the resulting sample was dried in a vacuum environment to finally obtain a three-dimensional interpenetrated porous composite copper foil.

Example 4: High-purity brass (containing 15 wt.-% of zinc) was used, which was sputtered to a substrate made of polyethylene terephthalate through uniform (magnetron) sputtering. A 1.5 μm-thick alloy layer was deposited on the two opposite sides of the substrate sheet. A 10*10 mm sample was taken and soaked in an 8 mol/L of hydrochloric acid solution at room temperature for 5 min. As the zinc in the sample gradually reacted with the hydrochloric acid solution, (hydrogen) bubbles appeared on the surface, and the color gradually changed from golden yellow to purple brown. After the reaction was over, the acidic solution was washed off with clean water, and the resulting sample was dried in a vacuum environment to finally obtain a three-dimensional interpenetrated porous composite copper foil.

Example 5: High-purity brass (containing 15 wt.-% of zinc) was used, which was sputtered to a substrate made of polyethylene terephthalate through uniform (magnetron) sputtering. A 1.5 μm-thick alloy layer was deposited on the two opposite sides of the substrate sheet. A 10*10 mm sample was taken and soaked in an 8 mol/L of hydrochloric acid solution at room temperature for 10 min. As the zinc in the sample gradually reacted with the hydrochloric acid solution, (hydrogen) bubbles appeared on the surface, and the color gradually changed from golden yellow to purple brown. After the reaction was over, the acidic solution was washed off with clean water, and the resulting sample was dried in a vacuum environment to finally obtain a three-dimensional interpenetrated porous composite copper foil.

Example 6: High-purity brass (containing 20 wt.-% of zinc) was used, which was sputtered to a substrate made of polyethylene terephthalate through uniform (magnetron) sputtering. A 1.5 μm-thick alloy layer was deposited on the two opposite sides of the substrate sheet. A 10*10 mm sample was taken and soaked in a 4 mol/L of hydrochloric acid solution at room temperature for 5 min. As the zinc in the sample gradually reacted with the hydrochloric acid solution, (hydrogen) bubbles appeared on the surface, and the color gradually changed from golden yellow to purple brown. After the reaction was over, the acidic solution was washed off with clean water, and the resulting sample was dried in a vacuum environment to finally obtain a three-dimensional interpenetrated porous composite copper foil.

Example 7: High-purity brass (containing 20 wt.-% of zinc) was used, which was sputtered to a substrate made of polyethylene terephthalate through uniform (magnetron) sputtering. A 1.5 μm-thick alloy layer was deposited on the two opposite sides of the substrate sheet. A 10*10 mm sample was taken and soaked in a 4 mol/L of hydrochloric acid solution at room temperature for 10 min. As the zinc in the sample gradually reacted with the hydrochloric acid solution, (hydrogen) bubbles appeared on the surface, and the color gradually changed from golden yellow to purple brown. After the reaction was over, the acidic solution was washed off with clean water, and the resulting sample was dried in a vacuum environment to finally obtain a three-dimensional interpenetrated porous composite copper foil.

Example 8: High-purity brass (containing 20 wt.-% of zinc) was used, which was sputtered to a substrate made of polyethylene terephthalate through uniform (magnetron) sputtering. A 1.5 μm-thick alloy layer was deposited on the two opposite sides of the substrate sheet. A 10*10 mm sample was taken and soaked in an 8 mol/L of hydrochloric acid solution at room temperature for 5 min. As the zinc in the sample gradually reacted with the hydrochloric acid solution, (hydrogen) bubbles appeared on the surface, and the color gradually changed from golden yellow to purple brown. After the reaction was over, the acidic solution was washed off with clean water, and the resulting sample was dried in a vacuum environment to finally obtain a three-dimensional interpenetrated porous composite copper foil.

Example 9: High-purity brass (containing 20 wt.-% of zinc) was used, which was sputtered to a substrate made of polyethylene terephthalate through uniform (magnetron) sputtering. A 1.5 μm-thick alloy layer was deposited on the two opposite sides of the substrate sheet. A 10*10 mm sample was taken and soaked in an 8 mol/L of hydrochloric acid solution at room temperature for 10 min. As the zinc in the sample gradually reacted with the hydrochloric acid solution, (hydrogen) bubbles appeared on the surface, and the color gradually changed from golden yellow to purple brown. After the reaction was over, the acidic solution was washed off with clean water, and the resulting sample was dried in a vacuum environment to finally obtain a three-dimensional interpenetrated porous composite copper foil.

Example 10: High-purity brass (containing 40 wt.-% of zinc) was, which was sputtered to a substrate made of polyethylene terephthalate through uniform (magnetron) sputtering. A 1.5 μm-thick alloy layer was deposited on the two opposite sides of the substrate sheet. A 10*10 mm sample was taken and soaked in an 8 mol/L of hydrochloric acid solution at room temperature for 10 min. As the zinc in the sample gradually reacted with the hydrochloric acid solution, (hydrogen) bubbles appeared on the surface, and the color gradually changed from golden yellow to purple brown. After the reaction was over, the acidic solution was washed off with clean water, and the resulting sample was dried in a vacuum environment to finally obtain a three-dimensional interpenetrated porous composite copper foil.

Example 11: High-purity manganese and copper were mixed to form a composition (containing 10 wt.-% of manganese), which was sputtered to a substrate made of polypropylene through uniform (magnetron) sputtering. A 1.5 μm-thick alloy layer was deposited on the two opposite sides of the substrate sheet. A 10*10 mm sample was taken and soaked in a 5 mol/L of hydrochloric acid solution at room temperature for 10 min. As the manganese in the sample gradually reacted with the hydrochloric acid solution, (hydrogen) bubbles appeared on the surface, and the color gradually changed to purple brown. After the reaction was over, the acidic solution was washed off with clean water, and the resulting sample was dried in a vacuum environment to finally obtain a three-dimensional interpenetrated porous composite copper foil.

Example 12: High-purity manganese and copper were mixed to form a composition (containing 30 wt.-% of manganese), which was sputtered to a substrate made of polypropylene through uniform (magnetron) sputtering. A 1.5 μm-thick alloy layer was deposited on the two opposite sides of the substrate sheet. A 10*10 mm sample was taken and soaked in a 5 mol/L of hydrochloric acid solution at room temperature for 10 min. As the manganese in the sample gradually reacted with the hydrochloric acid solution, (hydrogen) bubbles appeared on the surface, and the color gradually changed to purple brown. After the reaction was over, the acidic solution was washed off with clean water, and the resulting sample was dried in a vacuum environment to finally obtain a three-dimensional interpenetrated porous composite copper foil.

Example 13: The CuO film was prepared by the DC reactive magnetron sputtering method using helicon wave plasma. The pure Cu was sputtered with Ar in an O₂ atmosphere. The DC sputtering power was controlled within the range of 10-40 W. A Cu—CuO film was uniformly sputtered on a substrate made of polyethylene by controlling oxygen flow, wherein the content of CuO in the film was 10 wt.-%. A 10*10 mm sample was taken and soaked in a 5 mol/L of hydrochloric acid solution at room temperature for 10 min. As the CuO in the sample gradually reacted with the hydrochloric acid solution, the color gradually changed to purple brown. After the reaction was over, the acidic solution was washed off with clean water, and the resulting sample was dried in a vacuum environment to finally obtain a three-dimensional interpenetrated porous composite copper foil.

Example 14: The CuO film was prepared by the DC reactive magnetron sputtering method using helicon wave plasma. The pure Cu was sputtered with Ar in an O₂ atmosphere. The DC sputtering power was controlled within the range of 10-40 W. A Cu—CuO film was uniformly sputtered on a substrate made of polyethylene by controlling oxygen flow, wherein the content of CuO in the film was 30 wt.-%. A 10*10 mm sample was taken and soaked in a 5 mol/L of hydrochloric acid solution at room temperature for 10 min. As the CuO in the sample gradually reacted with the hydrochloric acid solution, the color gradually changed to purple brown. After the reaction was over, the acidic solution was washed off with clean water, and the resulting sample was dried in a vacuum environment to finally obtain a three-dimensional interpenetrated porous composite copper foil.

Example 15: High-purity brass (containing 20 wt.-% of zinc) was used, which was sputtered to a substrate made of polyethylene terephthalate through uniform (magnetron) sputtering. A 1.5 μm-thick alloy layer was deposited on the two opposite sides of the substrate sheet. A 10*10 mm sample was taken and soaked in a 5 mol/L of nitric acid solution at room temperature for 10 min. As the zinc in the sample gradually reacted with the nitric acid solution, (hydrogen) bubbles appeared on the surface, and the color gradually changed from golden yellow to purple brown. After the reaction was over, the acidic solution was washed off with clean water, and the resulting sample was dried in a vacuum environment to finally obtain a three-dimensional interpenetrated porous composite copper foil.

Example 16: High-purity brass (containing 20 wt.-% of zinc) was used, which was sputtered to a substrate made of polyethylene terephthalate through uniform (magnetron) sputtering. A 1.5 μm-thick alloy layer was deposited on the two opposite sides of the substrate sheet. A 10*10 mm sample was taken and soaked in a 5 mol/L of sulfuric acid solution at room temperature for 10 min. As the zinc in the sample gradually reacted with the sulfuric acid solution, (hydrogen) bubbles appeared on the surface, and the color gradually changed from golden yellow to purple brown. After the reaction was over, the acidic solution was washed off with clean water, and the resulting sample was dried in a vacuum environment to finally obtain a three-dimensional interpenetrated porous composite copper foil.

XRD patterns of the sample according to Example 11 were collected before and after the corrosion in the acidic solution. The XRD results are reflected in FIG. 4. The diagram shows the XRD patterns of the Cu—Mn film before and after the corrosion. It can be seen that the main diffraction peaks in the XRD patterns of the Cu—Mn film involve Cu—Mn alloy, and there is no obvious impurity peak. After the corrosion, the porous sample still showed pure Cu peaks, and the diffraction peaks shift to a low angle. It is clear that the Cu—Mn film can be dealloyed in the hydrochloric acid.

The characterization results of the samples of Examples 1 to 16 are summarized in Table 1. Once the actual porosity value calculated according to Equation 2 is equal to the completely reacted porosity value according to Equation 1, the specific example is noted as “completely reacted.”

TABLE 1

| | | Hydrochloric acid | | | |
|---|---|---|---|---|---|
| | Zn content | concentration | Soaking time | Pore size | |
| Example | (%) | (mol/L) | (min) | (nm) | Porosity (%) |
| 1 | 5 | 4 | 5 | 50-170 | 6 (completely |
| | | | | | reacted) |
| 2 | 15 | 4 | 5 | 50-200 | 15 |
| 3 | 15 | 4 | 10 | 50-250 | 17 |
| 4 | 15 | 8 | 5 | 50-230 | 16 |
| 5 | 15 | 8 | 10 | 50-280 | 18 (completely |
| | | | | | reacted) |
| 6 | 20 | 4 | 5 | 50-300 | 19 |
| 7 | 20 | 4 | 10 | 50-350 | 20 |
| 8 | 20 | 8 | 5 | 50-320 | 20 |
| 9 | 20 | 8 | 10 | 50-380 | 22 (completely |
| | | | | | reacted) |
| 10 | 40 | 8 | 10 | 50-420 | 45 (completely |
| | | | | | reacted) |

| | Mn | Hydrochloric acid | | | |
|---|---|---|---|---|---|
| | content | concentration | Soaking time | Pore size | |
| Example | (%) | (mol/L) | (min) | (nm) | Porosity (%) |
| 11 | 10 | 5 | 10 | 40-220 | 12 (completely |
| | | | | | reacted) |
| 12 | 30 | 5 | 10 | 40-390 | 34 (completely |
| | | | | | reacted) |
| | CuO | Hydrochloric acid | | | |
| | content | concentration | Soaking time | Pore size | |
| Example | (%) | (mol/L) | (min) | (nm) | Porosity (%) |
| 13 | 10 | 5 | 10 | 60-240 | 13 (completely |
| | | | | | reacted) |
| 14 | 30 | 5 | 10 | 60-410 | 37 (completely |
| | | | | | reacted) |

| | Zinc | Nitric acid | | | |
|---|---|---|---|---|---|
| | content | concentration | Soaking time | Pore size | |
| Example | (%) | (mol/L) | (min) | (nm) | Porosity (%) |
| 15 | 20 | 5 | 10 | 50-360 | 23 (completely |
| | | | | | reacted) |
| | Zinc | Sulfuric acid | | | |
| | content | concentration | Soaking time | Pore size | |
| Example | (%) | (mol/L) | (min) | (nm) | Porosity (%) |
| 16 | 20 | 5 | 10 | 50-360 | 23 (completely |
| | | | | | reacted) |

Compared with the existing methods, such as colloidal crystal template method, the laser-based blind hole processing method, and the solid-phase sintering method, the manufacturing methods disclosed herein can avoid using expensive equipment, and the operation steps are simpler.

In addition, the electrode disclosed herein, containing the composite current collector, may also contain, for example, positive electrode active material or negative electrode active material to form the positive electrode or negative electrode of a lithium-ion battery.

Further disclosed herein is a lithium-ion battery, which contains the composite current collector or electrode disclosed above. Compared with the existing smooth copper foil lithium-ion battery, the lithium-ion battery disclosed herein has great advantages in terms of coulombic efficiency and capacity after cyclic charging and discharging of the lithium-ion battery.

The technical features of the Examples above can be combined arbitrarily, and to be concise, not all possible combinations of the various technical features in the Examples above are described herein; however, as long as there is no contradiction in the combination of these technical features, all possible combinations thereof should be considered within the scope of this disclosure.

In addition, the Examples above only represent some embodiments of the present disclosure, and they should not be construed as a limitation on the scope of the present disclosure. It should be pointed out that, for those of ordinary skill in the art, without departing from the concept of the present disclosure, modifications and improvements can be made, and these all fall within the scope of the present disclosure.

1. A composite current collector, comprising:
a substrate;
a first porous conductive sheet; and
a second porous conductive sheet;
wherein the first porous conductive sheet and the second porous conductive sheet are laminated on the opposing surface of the substrate;
wherein the first porous conductive sheet and/or the second porous conductive sheet comprises amorphous micropores throughout the porous conductive sheets; and
wherein the first porous conductive sheet and the second porous conductive sheet are in conduction with each other in an electrode tab area.

2. The composite current collector of claim 1, wherein 80% or more of the micropores have a pore diameter ranging from 10 nm to 800 nm, preferably, 80% or more of the micropores have a pore diameter ranging from 50 nm to 400 nm.

3. The composite current collector of claim 1, wherein the first porous conductive sheet and/or the second porous conductive sheet has a porosity ranging from 5% to 50%, optionally, the first porous conductive sheet and/or the second porous conductive sheet has a porosity ranging from 10% to 30%.

4. The composite current collector of claim 1, wherein the material of the first porous conductive sheet and/or the second porous conductive sheet is metal and/or a metallic composition.

5. The composite current collector of claim 4, wherein the metal is copper.

6. The composite current collector of claim 4, wherein the metallic composition comprises copper.

7. The composite current collector of claim 6, wherein the metallic composition further comprises a second metallic compound which is capable to react with an acidic solution, optionally, the second metallic compound is selected from a second metal element and a metal oxide.

8. The composite current collector of claim 7, wherein the second metallic compound is one or more selected from manganese, zinc, magnesium, aluminum, and copper oxide.

9. The composite current collector of claim 5, wherein the content of copper is equal to or greater than 60 wt. %, preferably wherein the content of copper is equal to or greater than 80 wt. %.

10. The composite current collector of claim 1, wherein the thickness of the first porous conductive sheet and the second porous conductive sheet ranges independently from 0.8 μm to 2 μm.

11. The composite current collector of claim 1, wherein the substrate is made of a high-molecular-weight non-conductive material selected from polyethylene terephthalate, polypropylene, polyethylene, polyimide, polyether ether ketone, and the combination thereof.

12. The composite current collector of claim 1, wherein the thickness of the substrate ranges from 2 μm to 10 μm.

13. A method for making a composite current collector, comprising:
providing a substrate;
depositing a first metallic composition and a second metallic composition respectively on the opposite sides of the substrate, wherein the first metallic composition and the second metallic composition independently comprises copper and a second metallic compound; further wherein the second metallic compound is capable to react with an acidic solution;
contacting the deposited first and the second metallic compositions with an acid solution to form amorphous micropores;
washing away the acidic solution with clean water.

14. The method according to claim 13, wherein the first metallic composition and the second metallic composition are deposited on the substrate by vapor deposition.

15. The method according to claim 13, further comprising: performing anti-oxidation treatment for the composite current collector at a temperature ranging from 120° C. to 150° C.

16. The method according to claim 13, wherein the acidic solution comprises one or more acids selected from acetic acid, citric acid, hydrochloric acid, sulfuric acid, and nitric acid.

17. The method according to claim 13, wherein the first metallic composition and the second metallic composition independently contains copper ranging from 60% to 95% by weight of the total weight of the first metallic composition or the second metallic composition.

18. The method according to claim 13, wherein the molar concentration of the acidic solution ranges from 0.05 mol/L to 10 mol/L.

19. The method according to claim 12, wherein the first and the second metallic compositions are in contact with the acidic solution for a time period ranging from 5 minutes to 30 minutes.

20. The method according to claim 13, wherein the first and the second metallic compositions are in contact with the acidic solution at a temperature ranging from 20° C. to 70° C.

21. An electrode for lithium-ion secondary battery, comprising a composite current collector of claim 1.

22. A lithium-ion secondary battery, comprising an electrode of claim 21.
